(19) United States
(12) Patent Application Publication
(10) Pub. No.: US 2014/0103637 A1
(43) Pub. Date: Apr. 17, 2014

(54) COUPLERS

(71) Applicant: Benjamin Harrison Yates, JR., Santa Clara, CA (US)

(72) Inventors: James LU, Fremont, CA (US); Benjamin Harrison Yates, JR., Santa Clara, CA (US)

(21) Appl. No.: 13/653,336

(22) Filed: Oct. 16, 2012

(51) Int. Cl. F16L 37/00

(52) U.S. Cl. CPC F16L 37/00
USPC 285/33

(57) ABSTRACT

A coupler (for coupling a plug with a gas supply) may include a body having a first through hole and a second through hole. The coupler may further include a ring having a first cavity and a second cavity. The first cavity may be pneumatically disconnected from the second through hole when the ring is disposed at a first position with respect to the body. The first cavity may be pneumatically connected to both the first through hole and the second through hole when the ring is disposed at a second position with respect to the body. The second cavity may be pneumatically connected to the second through hole when the ring is disposed at the first position with respect to the body. The second cavity may be pneumatically disconnected from the second through hole when the ring is disposed at the second position with respect to the body.

### BACKGROUND OF THE INVENTION

The present invention is related to couplers. More particularly, the present invention is related to couplers for coupling a plug with a gas supply.

A coupler may be used for coupling a plug, e.g., an industrial plug, an automotive plug, or an ARO plug, to a gas supply. The gas supply may provide a gas, e.g., compressed air, through the coupler, the plug, and a hose to a pneumatic tool for driving the pneumatic tool.

Typically, when a plug is to be connected to a conventional coupler, given the resistance exerted by the gas pressure present at the coupler, substantial force and/or efforts may be required in ordered to successfully connect the plug to the coupler. The requirement of substantial force and/or efforts may lead to unsatisfactory user-friendliness of the coupler and unsatisfactory efficiency in utilizing the pneumatic tool.

### SUMMARY

An embodiment of the present invention may be related to a coupler for coupling a plug with a gas supply. The coupler may include a body having a first through hole and a second through hole. The coupler may further include a ring having a first cavity and a second cavity. The first cavity may be pneumatically disconnected from the second through hole when the ring is disposed at a first position with respect to the body. The first cavity may be pneumatically connected to both the first through hole and the second through hole when the ring is disposed at a second position with respect to the body. The second cavity may be pneumatically connected to the second through hole when the ring is disposed at the first position with respect to the body. The second cavity may be pneumatically disconnected from the second through hole when the ring is disposed at the second position with respect to the body.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a perspective view illustrating a coupler in accordance with one or more embodiments of the present invention.

FIG. 2 shows an exploded view illustrating a coupler in accordance with one or more embodiments of the present invention.

FIG. 3 shows a (front) elevational view illustrating a coupler in accordance with one or more embodiments of the present invention.

FIG. 4 shows a (side) elevational view illustrating a coupler in accordance with one or more embodiments of the present invention.

FIG. 5 shows a (side) elevational view illustrating a coupler in accordance with one or more embodiments of the present invention.

FIG. 6 shows a cross-sectional view illustrating a coupler, which can be coupled with various types of plugs, in accordance with one or more embodiments of the present invention.

FIG. 7 shows a cross-sectional view illustrating a coupler, which may substantially isolate gas pressure from a plug when receiving the plug, in accordance with one or more embodiments of the present invention.

FIG. 8 shows a cross-sectional view illustrating a coupler, which may substantially simultaneously engage a plug and form a gas transmitting path for supplying a gas through the plug, in accordance with one or more embodiments of the present invention.

FIG. 9 shows a cross-sectional view illustrating a coupler, which may substantially release gas pressure before being disengaging a plug, in accordance with one or more embodiments of the present invention.

FIG. 10 shows a cross-sectional view illustrating a coupler, which may include two movable rings and which may have been disconnected from a plug, in accordance with one or more embodiments of the present invention.

FIG. 11 shows a cross-sectional view illustrating a coupler, which may include a guide for guiding gas flows, in accordance with one or more embodiments of the present invention.

FIG. 12 shows a cross-sectional view illustrating a coupler, which may include a filter for filtering a gas provided from a gas supply, in accordance with one or more embodiments of the present invention.

### DETAILED DESCRIPTION

The present invention will now be described in detail with reference to a few embodiments thereof as illustrated in the accompanying drawings. In the following description, numerous specific details are set forth in order to provide thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Although the terms first, second, third etc. may be used herein to describe various signals, elements, components, regions, layers, and/or sections, these signals, elements, components, regions, layers, and/or sections should not be limited by these terms. These terms may be used to distinguish one signal, element, component, region, layer, or section from another signal, region, layer or section. Thus, a first signal, element, component, region, layer, or section discussed below may be termed a second signal, element, component, region, layer, or section without departing from the teachings of the present invention. The description of an element as “first” does not imply that second or other elements are needed. The terms first, second, third etc. may also be used herein to differentiate different categories of elements. For conciseness, the terms first, second, third, etc. may represent first-category, second-category, third-category, etc., respectively.

In the description, that a first space is pneumatically connected to a second space may mean a state in which a gas can substantially flow from the first space to the second space; that a first space is pneumatically disconnected from a second space may mean a state that substantially no gas can flow from the first space to the second space.

In the description, at least some occurrences of the term “when” may mean “whenever”.

One or more embodiments of the present invention may be related to a coupler for coupling a plug with a gas supply. The coupler may include a body having a first through hole and a second through hole. The coupler may further include a first ring having a first cavity and a second cavity. The first cavity may be pneumatically disconnected from the second through hole when the first ring is disposed at a first position with respect to the body. The first cavity may be pneumatically connected to both the first through hole and the second through hole when the first ring is disposed at a second position with respect to the body. The second cavity may be pneumatically connected to the second through hole when the first ring is disposed at the first position with respect to the body. The second cavity may be pneumatically disconnected from the second through hole when the first ring is disposed at the second position with respect to the body.

In one or more embodiments, the coupler may further include a first set of tactile features disposed at an outside of the first ring. The coupler may further include a second set of tactile features spaced from the first set of tactile features and disposed farther from the body than the first set of tactile features. The number of tactile features of the first set of tactile features is different from the number of tactile features of the second set of tactile features.

In one or more embodiments, the number of tactile features of the first set of tactile features may be greater than the number of tactile features of the second set of tactile features.

In one or more embodiments, the coupler may further include a second ring. A gas path for connecting the second cavity to an external environment that surrounds the coupler may be closed when the second ring is disposed at a third position with respect to the body and when the first ring is disposed at the first position with respect to the body. The gas path may be closed when the second ring is disposed at a fourth position with respect to the body and when the first ring is disposed at the second position with respect to the body. The gas path is open when the second ring is disposed at the fourth position with respect to the body and when the first ring is disposed at the first position with respect to the body.

In one or more embodiments, the first ring may include a first set of tactile features disposed at an outside of the first ring, and the second ring includes a second set of tactile features disposed at an outside of the second ring. The number of tactile features of the first set of tactile features may be different from the number of tactile features of the second set of tactile features.

In one or more embodiments, the gas path may extend between a first surface of the first ring and a first surface of the second ring. The first surface of the first ring may be an inner surface of the first ring and may surround the first surface of the second ring. The gas path may also extend between a second surface of the first ring and a second surface of the second ring. The second surface of the second ring may be substantially parallel to the second surface of the first ring.

In one or more embodiments, the coupler may further include a receiving unit configured to receive a portion of the plug. The receiving unit may have an aperture. The coupler may further include an engaging unit configured to move along the aperture. The engaging unit may engage the plug when the second ring is disposed at the fourth position with respect to the body.

In one or more embodiments, the second ring may a protrusion and a recess structure. The protrusion may prevent the engaging unit from moving away from the plug when the second ring is disposed at the fourth position with respect to the body. The recess structure may accommodate at least a portion of the engaging unit when the second ring is disposed at the third position with respect to the body.

In one or more embodiments, the coupler may further include an inner ring disposed inside the receiving unit. The inner ring may support the engaging unit such that the engaging unit is disposed between the inner ring and the second ring. The inner ring may be displaced by the plug when the portion of the plug is disposed inside the receiving unit.

In one or more embodiments, the coupler may further include a spring configured to return the inner ring to support the engaging unit.

In one or more embodiments, the coupler may further include a stopping unit protruding beyond a surface of the body. The first ring may further have a third cavity. The stopping unit may be disposed inside the third cavity when the first ring is disposed at the first position with respect to the body.

In one or more embodiments, the stopping unit may prevent the first ring from moving from the second position with respect to the body to the first position with respect to the body when the stopping unit is misaligned with the third cavity.

In one or more embodiments, the first ring may further have a fourth cavity. The fourth cavity may be disposed at an outer portion of the first ring and may be aligned with the stopping unit in an elevational view of the coupler when the third cavity is aligned with the stopping unit.

In one or more embodiments, the fourth cavity may indicate a direction of moving the first ring from the second position with respect to the body to the first position with respect to the body.

In one or more embodiments, the first ring may further have a fifth cavity. The fifth cavity may be aligned with the fourth cavity and may indicate a direction of moving the first ring from the second position with respect to the body to the first position with respect to the body.

In one or more embodiments, the first ring may have a sixth cavity. The sixth cavity may be disposed at an outer portion of the first ring and may indicate a direction of rotating the first ring with respect to the body for misaligning the third cavity with the stopping unit.

In one or more embodiments, the coupler may further include a guide disposed inside the body and configured to guide a gas provided from the gas supply. The body may have an input opening configured for receiving the gas provided from the gas supply. A first portion of the guide may be positioned closer to input opening than a second portion of the guide. A cross-sectional area of the first portion of the guide may be smaller than a cross-sectional area of the second portion of the guide.

In one or more embodiments, the coupler may further include a filter configured to filter the gas provided from the gas supply. A portion of the filter may surround the first portion of the guide.

In one or more embodiments, the coupler may further include a filter configured to filter a gas provided from the gas supply. The body may have an input opening configured for receiving the gas provided from the gas supply. A first portion of the filter may be positioned closer to the input opening than a second portion of the filter. A diameter of the first portion of the guide may be smaller than a diameter of the second portion of the guide.

In one or more embodiments, the coupler may further include a partition disposed between a first inner space inside the body and a second inner space inside the body. The coupler may further include a filter configured to filter a gas provided from the gas supply. The body may have an input opening configured for receiving the gas provided from the gas supply. The filter may be disposed between the partition and the input opening.

In one or more embodiments, the coupler may further include a guide disposed inside the body and configured to guide a gas provided from the gas supply. A first portion of the guide may be positioned farther to the second cavity than a second portion of the guide. A cross-sectional area of the first portion of the guide may be smaller than a cross-sectional area of the second portion of the guide.

In one or more embodiments, a third portion of the guide may be positioned closer to the first cavity than a fourth portion of the guide. The second portion of the guide and the third portion of the guide may be disposed between the first portion of the guide and the fourth portion of the guide. A cross-sectional area of the third portion of the guide may be larger than a cross-sectional area of the fourth portion of the guide.

In one or more embodiments, the coupler may further include a partition disposed between a first inner space inside the body and a second inner space inside the body. The coupler may further include a guide disposed inside the body and configured to guide a gas provided from the gas supply. The first inner space may be pneumatically connected to the first through hole. The second inner space may be pneumatically connected to the second through hole. A first portion of the guide may be positioned farther to the partition than a second portion of the guide. A cross-sectional area of the first portion of the guide may be smaller than a cross-sectional area of the second portion of the guide.

In one or more embodiments, a third portion of the guide may be positioned closer to the partition than a fourth portion of the guide. The second portion of the guide and the third portion of the guide may be disposed between the first portion of the guide and the fourth portion of the guide. A cross-sectional area of the third portion of the guide may be larger than a cross-sectional area of the fourth portion of the guide.

The features and advantages of the present invention may be better understood with reference to the figures and discussions that follow.

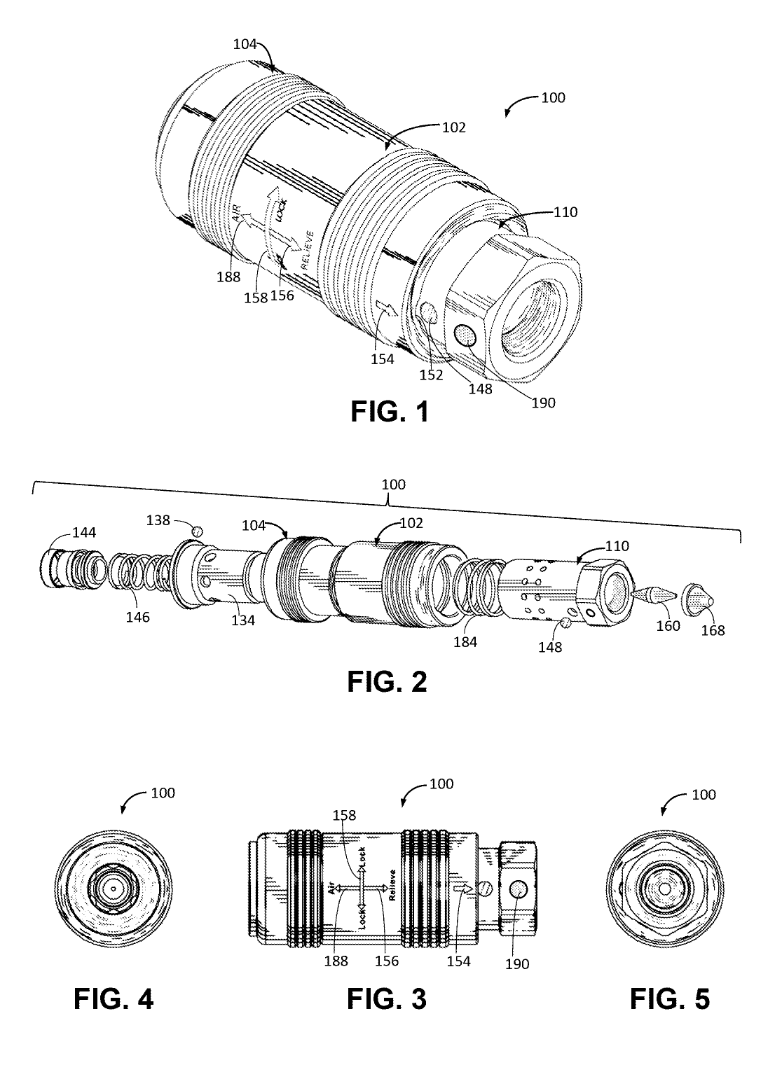

FIG. 1 shows a perspective view illustrating a coupler 100 in accordance with one or more embodiments of the present invention. FIG. 2 shows an exploded view illustrating the coupler 100 in accordance with one or more embodiments of the present invention. FIG. 3 shows a (front) elevational view illustrating the coupler 100 in accordance with one or more embodiments of the present invention. FIG. 4 shows a (side) elevational view illustrating the coupler 100 in accordance with one or more embodiments of the present invention. FIG. 5 shows a (side) elevational view illustrating the coupler 100 in accordance with one or more embodiments of the present invention.

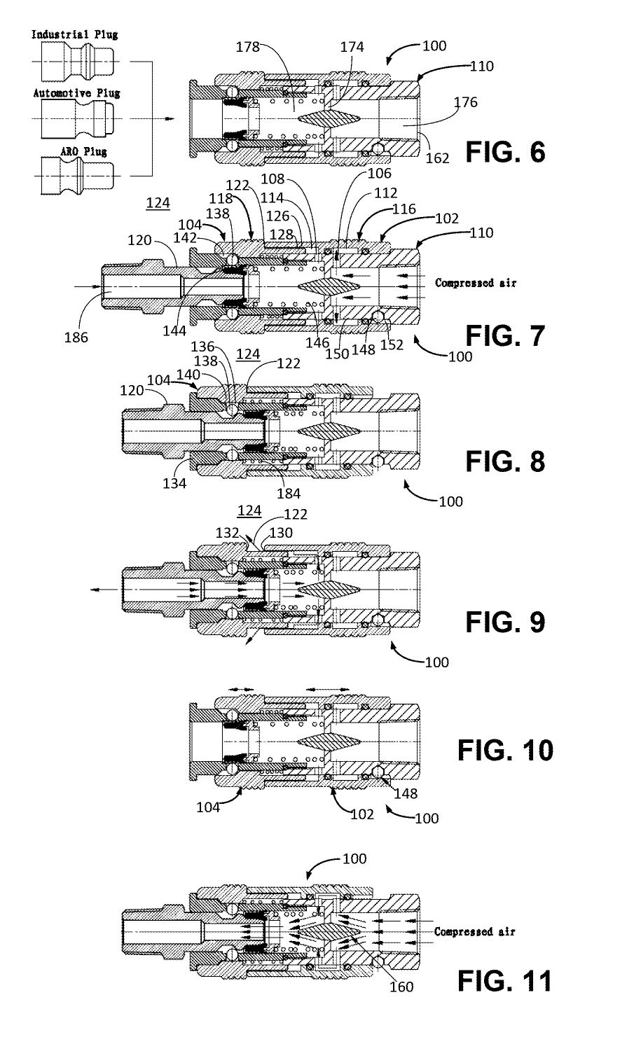

As illustrated in FIGS. 1-5, the coupler 100 may include one or more of the following components: a body 110 (configured to be coupled between a gas supply and a plug), a stopping unit 148, a spring 184, a ring 102, a ring 104, an engaging unit 138, a spring 146, an inner ring 144, a guide (or damper or dampler) 160, and a filter 168. Each of the ring 102 and the ring 104 may be movable with respect to the body 110 and may be disposed at various positions with respect to the body 110. For example, ring 102 may be disposed at a first position with respect to the body 110 and may be disposed at a second position with respect to the body 110; ring 104 may be disposed at a third position with respect to the body and may be disposed at a fourth position with respect to the body 110. The components are further discussed with reference to FIGS. 6-12.

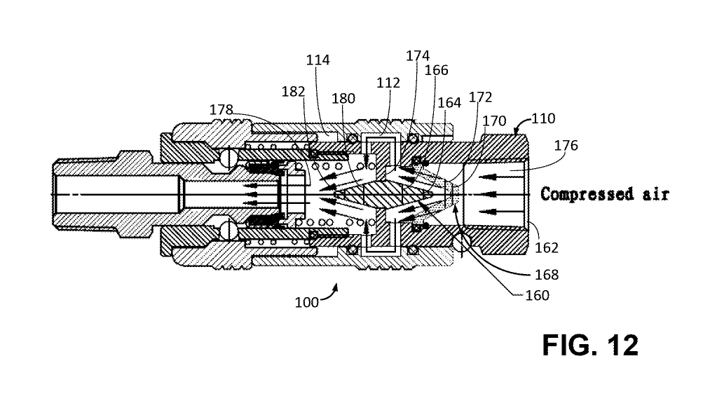

FIG. 6, FIG. 7, and FIG. 10 show cross-sectional views illustrating the coupler 100 with the ring 102 being disposed at the first position with respect to the body 110 and with the ring 104 being disposed at the third position with respect to the body 110. FIG. 8 and FIG. 11 show cross-sectional views illustrating the coupler 100 with the ring 102 being disposed at the second position with respect to the body 110 and with the ring 104 being disposed at the fourth position with respect to the body 110. FIG. 8 shows a cross-sectional view illustrating the coupler 100 with the ring 102 being disposed at the first position with respect to the body 110 and with the ring 104 being disposed at the fourth position with respect to the body 110. FIG. 12 shows a cross-sectional view illustrating features of the guide 160 and the filter 168 of the coupler 100.

FIG. 6 illustrates that the coupler 100 can be coupled with various types of plugs. FIG. 7 illustrates that the coupler 100 may substantially isolate gas pressure from a plug when receiving the plug. A first end of the coupler 100 may receive a gas, such as compressed air, from a gas supply (well-known and not shown). For example, the body 110 may have an input opening 162 for receiving the gas provided from the gas supply. A second end of the coupler 100 may be coupled with a plug 120, which may be, for example, an industrial plug, an automatic plug, or an ARO plug that is well-known in the art. The coupler 100 may include a tactile feature set 116 (e.g., a first set of groove features and/or ring features) disposed at an outside of the ring 102; the coupler 100 may further include a tactile feature set 118 (e.g., a second set of groove features and/or ring features) disposed at an outside of the ring 104, spaced from the tactile feature set 116, and disposed farther from the body 110 than the tactile feature set 116. The tactile features sets may facilitate gripping, handling, and movement of the ring 102 and the ring 104. The tactile feature set 116 may be disposed closer to the first end of the coupler 100 than the tactile feature set 118; the tactile feature set 118 may be disclosed closer to the second end of the coupler 100 than the tactile feature set 116. The number of tactile features of the tactile feature set 116 may be different from the number of tactile features of the tactile feature set 118. For example, the number of tactile features of the tactile feature set 116 may be greater than the number of tactile features of the tactile feature set 118. Accordingly, a user of the coupler 100 may recognize the first end of the coupler 100 for connecting to the gas supply and/or may recognize the second end of the coupler 100 for connecting to the plug 120 by simply touching (and/or feeling) the coupler 100 (without closely looking at the coupler 100). Advantageously, the connection of the coupler to the gas supply and/or to the plug 120 may be efficiently performed (even in a substantially dark environment).

The coupler 100 and/or the body 110 may include a partition 174 disposed between (and separating) an inner space 176 inside the body 110 and an inner space 178 inside the body 110. The inner space 176 may be pneumatically connected to the gas supply for receiving the compressed air. The inner space 178 may be pneumatically connected to a channel 186 of the plug 120. The body 110 may have a through hole 106 that is pneumatically connected to the inner space 176; the body 110 may have a through hole 108 that is pneumatically connected to the inner space 178. The through hole 106 may be one of a plurality of through holes disposed along a circumference of the body 110 and pneumatically connected to the inner space 176; the through hole 108 may be one of another plurality of through holes disposed along a another circumference of the body 110 and pneumatically connected to the inner space 178.

The ring 102 may have a cavity 112 and a cavity 114. As illustrated in at least FIG. 6 and FIG. 7, the cavity 112 may be pneumatically disconnected from the through hole 108 and the inner space 178 when the ring 102 is disposed at the first position with respect to the body 110. Accordingly, the compress air may not flow to the inner space 178, and the plug 120 may not receive any substantial resistance exerted by the compressed air when the plug 120 is connected to the coupler 100. Advantageously, the plug 120 may be substantially easily connected to the coupler 100, and the pneumatic tool associated with the plug 120 may be efficiently operated.

FIG. 8 illustrates that the coupler 100 may engage the plug 120 and may form a gas transmitting path for supplying a gas through the plug 120 substantially simultaneously. As illustrated in at least FIG. 8, the cavity 112 may be pneumatically connected to both the through hole 106 and the through hole 108 when the ring 102 is disposed at the second position with respect to the body 110 (and when the ring 104 is disposed at the fourth position with respect to the body 110). Accordingly, compressed air may be applied through a gas transmitting path that extends through the inner space 176, the through hole 106, the chamber 112, the through hole 108, the inner space 178, and the channel 186 of the plug 120, bypassing the partition 174, to effectively drive the pneumatic tool. When the ring 102 is disposed at the second position with respect to the body 110, the cavity 114 may be pneumatically disconnected from the through hole 108 and the inner space 178, such that air leakage may be prevented when the compressed air is used to drive the pneumatic tool.

The receiving unit 134 may receive a portion of the plug 120. The receiving unit 134 may have an aperture (or tunnel) 136. The engaging unit 138 (which may have a ball shape) may move along the aperture 136 and may engage the plug 120 when the ring 104 is disposed at the fourth position with respect to the body 110.

The ring 104 may have a protrusion 140 and a recess structure 142. The protrusion 140 may prevent the engaging unit 138 from moving away from the plug 120 when the ring 104 is disposed at the fourth position with respect to the body 110. The spring 184 may bias the ring 104 toward the fourth position, for securing the plug 120. The recess structure 142 may accommodate at least a portion of the engaging unit 138 when the ring 104 is disposed at the third position with respect to the body 110.

The inner ring 144 may be disposed inside the receiving unit 134 and may support the engaging unit 138 such that the engaging unit 138 is disposed between the inner ring 144 and the ring 104. The inner ring 144 may be displaced by the plug 120 when a portion of the plug 120 is disposed inside the receiving unit 134. The spring 146 may return the inner ring 144 to support the engaging unit 138 when the plug 120 is removed from the receiving unit 134.

In one or more embodiments, the coupler 100 may include one or more other engaging units that have features and functions analogous to those of the engaging 138, and the receiving unit 134 may have one or more other apertures (or tunnels) that are disposed along a circumference of the receiving unit 134 and have features and functions analogous to those of the aperture (or tunnel) 136.

As can be appreciated from FIG. 7, FIG. 8, and related discussion, when the ring 102 is moved from the first position with respect to the body 110 to the second position with respect to the body 110, the ring 102 may push the ring 104 to move from the third position with respect to the body 110 to the fourth position with respect to the body 110. Advantageously, two tasks (engaging the plug 120 and forming the gas transmitting path for supplying gas through the plug 120) may be accomplished through a single action (moving the ring 102 to the second position with respect to the body 110). The ring 102 may be secured at the second position with respect to the body 110 by the stopping unit 148 through a rotation of the ring 102.

The stopping unit 148 may protrude beyond a surface 150 of the body 110. For example, the stopping unit 148 may be a ball partially disposed in a receptacle of the body 110 and partially exposed outside the receptacle. The ring 102 may further have a cavity 152. The stopping unit 148 may be disposed inside the cavity 152 when the ring 102 is disposed at the first position with respect to the body 110.

The stopping unit 148 may prevent the ring 102 from moving from the second position with respect to the body 110 to the first position with respect to the body 110 (when the stopping unit 148 is misaligned with the cavity 152 after a rotation of the ring 102). Advantageously, the rings 102 and 104 may be substantially secured in place, the gas transmitting path may be substantially stably maintained, and the gas may be substantially stably supplied to the plug 120.

The ring 102 may further have a cavity 154 (illustrated in FIG. 1 and FIG. 3). The cavity 154 may be disposed at an outer portion of the ring 102 and may be aligned with the stopping unit 148 in an elevational view of the coupler 100 when the cavity 152 is aligned with the stopping unit 148. The body 110 may include a marking 190 (e.g., a cavity illustrated in FIG. 1 and FIG. 3) disposed at an outer portion of the body 110 and aligned with the stopping unit 148. The marking 190 and the cavity 154 may facilitate the alignment between the cavity 152 and the stopping unit 148.

The cavity 154 may indicate a direction of moving the ring 102 from the second position with respect to the body 110 to the first position with respect to the body 110. For example, the cavity 154 may have an arrow shape.

The ring 102 may further have a cavity 156 (illustrated in FIG. 1 and FIG. 3). The cavity 156 may be aligned with the cavity 154 (in the elevational view of the coupler 100) and may indicate a direction of moving the ring 102 from the second position with respect to the body 110 to the first position with respect to the body 110.

The ring 102 may further have a cavity 158 (illustrated in FIG. 1 and FIG. 3). The cavity 158 may be disposed at an outer portion of the ring 102 and may indicate at least a direction (e.g., two directions) of rotating the ring 102 with respect to the body 110 for misaligning the cavity 152 with the stopping unit 148 (such that the ring 102 and the ring 104 are locked in place and that translation of the ring 102 and the ring 104 with respect to the body 110 may be prevented).

The ring 102 may further have a cavity 188 (illustrated in FIG. 1 and FIG. 3). The cavity 188 may be disposed at an outer portion of the ring 102 and may indicate an appropriate gas flow direction (or gas supply direction) for use of the coupler 100.

One or more of the cavity 154, the cavity 156, the cavity 158, and the cavity 188 may be formed through, for example, laser etching or engraving. One or more color elements, e.g., paint, may be disposed inside one or more of the cavity 154, the cavity 156, the cavity 158, and the cavity 188. Even if the one or more color elements were worn off after substantial use of the coupler 100, the cavities may still provide clear instructions to the user(s) of the coupler 100. The ring may further have one or more verbal (or text) instructions disposed at an outer portion of the ring 102 and accompanying one or more of the cavity 154, the cavity 156, the cavity 158, and the cavity 188.

FIG. 9 illustrates that the coupler 100 may substantially release gas pressure before disengaging the plug 120. As illustrated in at least FIG. 9, the cavity 114 may be pneumatically connected to the through hole 108 and the inner space 178 when the ring 102 is disposed at the first position with respect to the body 110 and when the ring 104 is disposed at the fourth position with respect to the body 110. Accordingly, the gas (e.g., air) may be released from the inner space 178 through the cavity 114 before an attempt to disengage the plug 120 and to disconnect the plug 120 from the coupler 100. Advantageously, the plug 120 may be substantially safely disconnected from the coupler 100.

The coupler 100 may have a gas release path 122 that may extend through a gap between the rings 102 and 104) for connecting the cavity 114 to an external environment 124 that surrounds the coupler 100. The gas release path 122 may extend between a surface 126 of the ring 102 and a surface 128 of the ring 104. The surface 126 of the ring 102 may be an inner surface of the ring 102 and may surround the surface 128 of the ring 104. The gas release path 122 may extend between a surface 130 of the ring 102 and a surface 132 of the ring 104. The surface 130 of the ring 104 may substantially parallel to and/or may be substantially complementary to the surface 132 of the ring 102. Accordingly, when the surface 130 is attached to or engages the surface 132, air leakage may be prevented.

The gas release path 122 may be closed (or blocked) when the ring 104 is disposed at the third position with respect to the body 110 and when the ring 102 is disposed at the first position with respect to the body 110. When the plug 120 is not engaged by the coupler 100, there may be no need for releasing gas pressure through the gas release path 122.

The gas release path 122 may closed (or blocked) when the ring 104 is disposed at the fourth position with respect to the body 110 and when the ring 102 is disposed at the second position with respect to the body 110. Accordingly, when the plug 120 is engaged by the coupler 100, the gas (e.g., compressed air) may be supplied through the coupler 120 to the plug 120 without substantial gas leakage.

The gas release path 122 may be open (or unblocked) when the ring 104 is disposed at the fourth position with respect to the body 110 and when the ring 102 is disposed at the first position with respect to the body 110. Accordingly, before an attempt to disengage the plug 120 while the plug 120 is still engaged by the coupler 100, a substantial amount of gas (e.g. air) may be released from the inner space 178 through the through hole 108, the cavity 114, and the gas release path 122 to the external environment 124. Advantageously, the plug 120 may be substantially safely disconnected from the coupler 100.

FIG. 10 illustrates that the coupler 100 may have been disconnected from the plug 120. FIG. 10 further illustrates that the ring 102 and the ring 104 may be movable (for performing one or more of plug-engaging, plug-disengaging, gas-path-forming, and gas-path-blocking tasks). FIG. 10 further illustrates the stopping unit 148, which may secure the rings 102 and 104 in place and may be accommodated by the ring 102.

FIG. 11 illustrates that the coupler 100 may include the guide 160 for guiding gas flows. FIG. 12 illustrates that the coupler 100 may include the filter 168 for filtering a gas (e.g., compressed air) provided from a gas supply.

The guide 160 may be disposed inside the body 110. The guide 160 may guide the gas provided from the gas supply toward the through hole 106 (and other through holes of the first plurality of through holes). The guide 160 may further guide the gas transmitted through the through hole 108 (and other through holes of the second plurality of through holes) toward the plug 120. The guide 160 may effectively minimize conflict between gas flows. Advantageously, gas may be substantially smoothly supplied, and energy may be conserved.

As illustrated in FIG. 12, a portion 164 of the guide 160 may be positioned closer to the input opening 162 than a portion 166 of the guide 160. The portion 164 may be positioned farther to the cavity 114 and/or farther to the through hole 106 than the portion 166 of the guide 160. The portion 164 may be positioned farther to the partition 174 than the portion 166 of the guide 160. The cross-sectional area of the portion 164 of the guide 160 may be smaller than the cross-sectional area of the portion 166 of the guide 160.

As illustrated in FIG. 12, a portion 180 of the guide 160 may be positioned closer to the cavity 112 and/or closer to the through hole 108 the than a portion 182 of the guide 160. The portion 180 of the guide 160 may be positioned closer to the partition 174 than the portion 182 of the guide 160. The portion 166 of the guide 160 and the portion 180 of the guide 160 may be disposed between the portion 164 of the guide 160 and the portion 182 of the guide 160. The cross-sectional area of the portion 180 of the guide 160 may be larger than the cross-sectional area of the portion 182 of the guide 160.

The filter 168 (illustrated in FIG. 12) may be disposed inside the body 110 and may be disposed between the partition 174 and the input opening 162. The filter 168 may filter the gas provided from the gas supply. Advantageously, the gas supplied through the coupler may substantially satisfy cleanness requirements, and there may be substantially no need to implement filters in plugs, such that the total material cost and/or replacement cost for filters may be minimized. A portion of the filter 168 may surround the portion 164 of the guide 160, such that the gas may be filtered before contacting the guide 160, and contamination on and/or damage to the guide 160 may be minimized.

The filter 168 may have a cone shape to provide a maximized filtering area. In particular, a portion 170 of the filter 168 may be positioned closer to input opening 162 than a portion 172 of the filter 168, and a diameter of the 170 portion of the guide 160 may be smaller than a diameter of the portion 172 of the guide 160.

As can be appreciated from the foregoing, embodiments of the invention may effectively isolate gas pressure when a plug is to be connected to a coupler. Embodiments of the invention also may provide tactile instructions for connecting a coupler to a plug and/or to a gas supply. Advantageously, embodiments of the invention may enable substantially easy and efficient connection of a pneumatic tool to a gas supply.

Embodiments of the invention may effectively release gas pressure when a plug is to be disconnected from a coupler. Advantageously, embodiments of the invention may enable substantially safe disconnection of the plug from the coupler.

Embodiments of the invention may effectively minimize conflict between gas flows. Advantageously, gas may be substantially smoothly supplied, and energy may be conserved.

Embodiments of the invention may substantially enable a gas supplied through a coupler to satisfy cleanness requirements. Accordingly, embodiments of the invention may substantially reduce or eliminate the need of implementing filters in numerous plugs. Advantageously, the total material cost and/or replacement cost for filters may be minimized.

While this invention has been described in terms of several embodiments, there are alterations, permutations, and equivalents, which fall within the scope of this invention. It should also be noted that there are many alternative ways of implementing the methods and apparatuses of the present invention. Furthermore, embodiments of the present invention may find utility in other applications. The abstract section is provided herein for convenience and, due to word count limitation, is accordingly written for reading convenience and should not be employed to limit the scope of the claims. It is therefore intended that the following appended claims be interpreted as including all such alterations, permutations, and equivalents as fall within the true spirit and scope of the present invention.

What is claimed is:

1. A coupler for coupling a plug with a gas supply, the coupler comprising:
a body having a first through hole and a second through hole; and
a first ring having a first cavity and a second cavity, the first cavity being configured to be pneumatically disconnected from the second through hole when the first ring is disposed at a first position with respect to the body, the first cavity being configured to be pneumatically connected to both the first through hole and the second through hole when the first ring is disposed at a second position with respect to the body, the second cavity being configured to be pneumatically connected to the second through hole when the first ring is disposed at the first position with respect to the body, the second cavity being configured to be pneumatically disconnected from the second through hole when the first ring is disposed at the second position with respect to the body.

2. The coupler of claim 1, further comprising:
a first set of tactile features disposed at an outside of the first ring; and
a second set of tactile features spaced from the first set of tactile features and disposed farther from the body than the first set of tactile features,
wherein the number of tactile features of the first set of tactile features is different from the number of tactile features of the second set of tactile features.

3. The coupler of claim 2, wherein the number of tactile features of the first set of tactile features is greater than the number of tactile features of the second set of tactile features.

4. The coupler of claim 1, further comprising a second ring, wherein a gas path for connecting the second cavity to an external environment that surrounds the coupler is closed when the second ring is disposed at a third position with respect to the body and when the first ring is disposed at the first position with respect to the body, wherein the gas path is closed when the second ring is disposed at a fourth position with respect to the body and when the first ring is disposed at the second position with respect to the body, and wherein the gas path is open when the second ring is disposed at the fourth position with respect to the body and when the first ring is disposed at the first position with respect to the body.

5. The coupler of claim 4,
wherein the first ring includes a first set of tactile features disposed at an outside of the first ring,
wherein the second ring includes a second set of tactile features disposed at an outside of the second ring, and
wherein the number of tactile features of the first set of tactile features is different from the number of tactile features of the second set of tactile features.

6. The coupler of claim 4, wherein the gas path extends between a first surface of the first ring and a first surface of the second ring.

7. The coupler of claim 6,
wherein the gas path extends between a second surface of the first ring and a second surface of the second ring, and
wherein the second surface of the second ring is substantially parallel to the second surface of the first ring.

8. The coupler of claim 6, wherein the first surface of the first ring is an inner surface of the first ring.

9. The coupler of claim 4, further comprising:
a receiving unit configured to receive a portion of the plug, the receiving unit having an aperture; and
an engaging unit configured to move along the aperture, the engaging unit being further configured to engage the plug when the second ring is disposed at the fourth position with respect to the body,
wherein the second ring has a protrusion and a recess structure,
wherein the protrusion is configured to prevent the engaging unit from moving away from the plug when the second ring is disposed at the fourth position with respect to the body, and
wherein the recess structure is configured to accommodate at least a portion of the engaging unit when the second ring is disposed at the third position with respect to the body.

10. The coupler of claim 9, further comprising an inner ring disposed inside the receiving unit, the inner ring being configured to support the engaging unit such that the engaging unit is disposed between the inner ring and the second ring, the inner ring being further configured to be displaced by the plug when the portion of the plug is disposed inside the receiving unit.

11. The coupler of claim 10, further comprising a spring configured to return the inner ring to support the engaging unit.

12. The coupler of claim 1, further comprising a stopping unit protruding beyond a surface of the body, wherein the first ring further has a third cavity, wherein the stopping unit is configured to be disposed inside the third cavity when the first ring is disposed at the first position with respect to the body.

13. The coupler of claim 12, wherein the stopping unit is further configured to prevent the first ring from moving from the second position with respect to the body to the first position with respect to the body when the stopping unit is misaligned with the third cavity.

14. The coupler of claim 12, wherein the first ring further has a fourth cavity, the fourth cavity being disposed at an outer portion of the first ring and being configured to be aligned with the stopping unit in an elevational view of the coupler when the third cavity is aligned with the stopping unit.

15. The coupler of claim 14, wherein the fourth cavity is further configured to indicate a direction of moving the first ring from the second position with respect to the body to the first position with respect to the body.

16. The coupler of claim 14, wherein the first ring further has a fifth cavity, the fifth cavity being aligned with the fourth cavity and being configured to indicate a direction of moving the first ring from the second position with respect to the body to the first position with respect to the body.

17. The coupler of claim 12, wherein the first ring further has a fourth cavity, the fourth cavity being disposed at an outer portion of the first ring and configured to indicate a direction of rotating the first ring with respect to the body for misaligning the third cavity with the stopping unit.

18. The coupler of claim 1, further comprising a guide disposed inside the body and configured to guide a gas provided from the gas supply,
wherein the body has an input opening configured for receiving the gas provided from the gas supply,
wherein a first portion of the guide is positioned closer to input opening than a second portion of the guide, and
wherein a cross-sectional area of the first portion of the guide is smaller than a cross-sectional area of the second portion of the guide.

19. The coupler of claim 18, further comprising a filter configured to filter the gas provided from the gas supply, wherein a portion of the filter surrounds the first portion of the guide.

20. The coupler of claim 1, further comprising a filter configured to filter a gas provided from the gas supply,
wherein the body has an input opening configured for receiving the gas provided from the gas supply,
wherein a first portion of the filter is positioned closer to the input opening than a second portion of the filter, and
wherein a diameter of the first portion of the guide is smaller than a diameter of the second portion of the guide.

21. The coupler of claim 1, further comprising:
a partition disposed between a first inner space inside the body and a second inner space inside the body; and
a filter configured to filter a gas provided from the gas supply,
wherein the body further has an input opening configured for receiving the gas provided from the gas supply, and
wherein the filter is disposed between the partition and the input opening.

22. The coupler of claim 1, further comprising a guide disposed inside the body and configured to guide a gas provided from the gas supply,
wherein a first portion of the guide is positioned farther to the second cavity than a second portion of the guide, and
wherein a cross-sectional area of the first portion of the guide is smaller than a cross-sectional area of the second portion of the guide.

23. The coupler of claim 22,
wherein a third portion of the guide is positioned closer to the first cavity than a fourth portion of the guide,
wherein the second portion of the guide and the third portion of the guide are disposed between the first portion of the guide and the fourth portion of the guide, and
wherein a cross-sectional area of the third portion of the guide is larger than a cross-sectional area of the fourth portion of the guide.

24. The coupler of claim 1, further comprising:
a partition disposed between a first inner space inside the body and a second inner space inside the body; and
a guide disposed inside the body and configured to guide a gas provided from the gas supply,
wherein the first inner space is pneumatically connected to the first through hole,
wherein the second inner space is pneumatically connected to the second through hole,
wherein a first portion of the guide is positioned farther to the partition than a second portion of the guide, and
wherein a cross-sectional area of the first portion of the guide is smaller than a cross-sectional area of the second portion of the guide.

25. The coupler of claim 24,
wherein a third portion of the guide is positioned closer to the partition than a fourth portion of the guide,
wherein the second portion of the guide and the third portion of the guide are disposed between the first portion of the guide and the fourth portion of the guide, and
wherein a cross-sectional area of the third portion of the guide is larger than a cross-sectional area of the fourth portion of the guide.
